(19) United States
(12) Patent Application Publication
(10) Pub. No.: US 2010/0167857 A1
(43) Pub. Date: Jul. 1, 2010

(54) RESONANCE TENSION REDUCING SPROCKET WITH COMBINED RADIAL VARIATION AND SPROCKET WRAP

(75) Inventor: Kevin B. Todd, Freeville, NY (US)

Correspondence Address: BorgWarner Inc.;c/o Fitch, Even, Tabin & Flannery, 120 South LaSalle Street, Suite 1600, Chicago, IL, 60603-3406, US

(73) Assignee: BORGWARNER INC., Auburn Hills, MI (US)

(21) Appl. No.: 11/995,844

(22) PCT Filed: Jun. 20, 2007
(86) PCT No.: PCT/US2007/071682

§ 371 Date: Mar. 3, 2010

(51) Int. Cl. F16H 55/30; F16H 55/02; F16H 55/14; F16H 7/06

(52) U.S. Cl. 474/156; 474/155

(57) ABSTRACT

In a chain and sprocket assembly, the order of the sprocket and the wrap angle of the chain are selected such that the resonance tension of the chain and sprocket assembly is minimized.

### FIELD

The invention pertains to the field of pulleys and sprockets. More particularly, the invention pertains to a chain and sprocket for reducing resonance tension.

### BACKGROUND AND DESCRIPTION OF RELATED ART

Chain and sprocket systems are often used in automotive engine systems to transmit rotational forces between shafts. For example, a sprocket on a driven shaft may be connected via a chain to a sprocket on an idler shaft. In such a chain and sprocket system, rotation of the driven shaft and driven sprocket will cause the rotation of the idler shaft and idler sprocket via the chain. In an automotive engine system, sprockets on the crankshaft may be used to drive one or more cam shaft sprockets.

The chains used in chain and sprocket systems typically comprise a plurality of link plates connected with pins or rollers or chains with the plurality of link plates having engagement teeth connected with pins and/or links. The sprockets typically comprise a circular plate having a plurality of teeth disposed around the circumference thereof. Located between adjacent teeth are roots having generally arcuate or semi-circular profiles for receiving the pins, rollers, or teeth of the chain. Each root has a root radius which is the distance from the center of the sprocket to a point along the root closest to the center of the sprocket. The sprocket roots and/or teeth are also associated with a pitch radius, which is the distance from the center of the sprocket to a pin axis which is part of a chain joint when the chain is seated on the sprocket.

In a conventional (“straight”) sprocket, the root radii are all substantially equal, and the sprocket's pitch radii also are substantially equal. However, it has been found that as a chain rotates around a straight sprocket, audible sound frequencies creating undesirable noise are often generated as the chain teeth, pins or rollers connecting the links of the chain contact the sprocket teeth and impact sprocket engagement surfaces or the roots disposed between adjacent teeth of the sprockets.

Sound frequencies and volume of such noise created by the operation of chain and sprocket systems typically vary depending on the chain and sprocket designs, chain rotational speed, and other sound or noise sources in the operating environment. In the design of chain and sprocket systems, it can be desirable to reduce the noise levels generated as the rollers, pins or teeth of a chain engage a sprocket.

In chain tension measurements, certain chain tensions originating from occurrences outside the chain and/or sprocket in a particular system may vary on a periodic or repeating basis, which often can be correlated to tension inducing events. For example, in automotive timing chain systems, it has been observed from chain tension measurements that the engagement and disengagement of each sprocket tooth or root with the chain often results in repeating tension changes. These chain tension changes may be correlated with potentially tension-inducing events, such as the firing of piston cylinders. Reducing these tensions and forces on chains is of particular importance if the chains include elements where they do not have the properties of steel, such as ceramic elements as described in U.S. application Ser. No. 10/379,669.

The number of tension events that occur relative to a reference time period, as well as the amount of the tension change for each event may be observed. For example, in an automotive timing chain system, one may observe the number or frequency of tension changes in the chain relative to rotations of a sprocket or a crankshaft, as well as the magnitude of the tension change in the chain. A tensioning event that occurs once per shaft or sprocket rotation is considered a “first” order event, and an event occurring four times for each shaft or sprocket rotation is considered a “fourth” order event. Depending on the system and the relative reference period, i.e., rotations of the crankshaft or the sprocket (or another reference), there may be multiple “orders” of events in a crankshaft or sprocket rotation in such a system that originate from one or more tension sources outside the chain and sprocket. Similarly, a particular order of the sprocket rotation may include or reflect the cumulative effect of more than one tensioning event. As used herein, such orders of tensioning events occurring during a sprocket (or crankshaft) rotation also may be referred to as the orders of the sprocket (or crankshaft) or the sprocket orders (or crankshaft orders).

In straight sprockets, measurable tensions typically are imparted to the chain at a sprocket order corresponding to the number of teeth on the sprocket, also known as the pitch order. Thus, in a sprocket with nineteen teeth, tensions would be imparted to the chain at the nineteenth order, i.e., nineteen times per revolution of the sprocket. This is engagement order. A tension event in a straight sprocket originating from outside the sprocket would typically occur at equal intervals relative to the sprocket rotation, with a generally equal tension change or amplitude.

A “random” sprocket typically has root and/or pitch radii that vary around the sprocket, i.e. it is not a straight sprocket. Random sprockets, in contrast, typically have different tensioning characteristics when compared to straight sprockets due to their differing root or pitch radii. As the chain rotates around the random sprocket, each of the different radii typically imparts a different tensioning event to the chain. For instance, as a roller of a roller chain engages a root having a first root radius, the chain may be imparted with a tension different from when a roller of the chain engages a root having a second root radius larger than the first root radius. Tension changes, in addition, may also be imparted to the chain by a random sprocket due to the relative positioning of the different root radii. A roller moving between adjacent roots having the same root radii may result in different chain tension changes than a roller moving between adjacent roots having different radii.

The change in chain tensions imparted by random sprockets due to the relative positioning of the root and/or pitch radii may be further accentuated when the sprocket has more than two different root or pitch radii. For example, in a random sprocket having first, second, and third successively larger root radii, the tension imparted to the chain may be greater when a chain roller moves from a root having a first root radii to a root having a third root radii than when a chain roller moves from a root having a first root radii to a root having a second root radii.

Random sprockets designed principally for noise reduction often cause increases in chain tensions and tension changes as compared to the maximum tensions imparted to the chain by straight sprockets. For example, a random sprocket design may reduce chain noise or chain whine by reducing the pitch order of the sprocket. However, reducing the pitch order of a sprocket may result in concentrating the tensional forces imparted to the chain by the sprocket over the lower orders of the sprocket. These lower orders can excite a chain drive resonance. This often results in increased chain tensions corresponding to the lower orders of the random sprocket.

Such increased chain tensions at the lower sprocket orders frequently cause the overall maximum chain tension force exerted on the chain and sprocket to increase. As a consequence, a chain and sprocket system subjected to such tensions typically will experience greater wear and increased opportunities for failure, as well as other adverse effects, due to the concentration of the tensional forces in the lower orders.

A recently issued U.S. Pat. No. 7,125,356 to Todd entitled “TENSION-REDUCING RANDOM SPROCKET” describes one approach for reducing chain tensions using repeating root and/or pitch radii patterns at resonance conditions. The patent describes patterns or sequences effective to impart tensions to the chain at one or more sprocket orders to reduce maximum chain tensions during operation of the system relative to maximum chain tensions of a system where the sprocket is a straight sprocket operating at resonance conditions. The disclosure of U.S. Pat. No. 7,125,356 to Todd is incorporated herein as if completely rewritten into this disclosure.

There are times, however, when the sequence of varying root or pitch radii should be coordinated with sprocket order and sprocket size to achieve maximum effectiveness in reducing maximum chain tensions especially at resonance. Maximum reduction of chain tensions not only is a function of a sequence or pattern of root or pitch radii and/or repeating patterns of root or pitch radii, but such reduction of chain tensions also depends upon coordinating the wrap angle of the chain around the sprocket with the repeating patterns and sprocket order.

### SUMMARY

A sprocket wrapped with a chain at specific chain wrap angles is provided where the sprocket has a wrap angle with the chain and has a root radius (the distance from the center of the sprocket to a point along the root closest to the center of the sprocket) pattern or sequence, or pitch radius (the distance from the center of the sprocket to a pin axis which is part of a chain joint when the chain is seated on the sprocket) pattern or sequence. The chain wrap angle, sprocket order and patterns or sequences are coordinated and are selected to reduce maximum chain tensions at a predetermined order or at multiple predetermined orders relative to the sprocket rotation or another reference, such as, for example, the rotation of a crankshaft in automotive timing chain applications. The sprocket with the latter sequences, order and selected chain wrap angle provide reduced overall chain tensions and also may simultaneously reduce chain noise. Such overall reduction would be particularly useful with chains with ceramic elements as described in U.S. application Ser. No. 10/379,669 which is incorporated by reference as fully rewritten herein.

The order or orders of the sprocket may be chosen to at least partially cancel corresponding tensions imparted to the chain from sources external to the sprocket. By coordinating the maximum tensions imparted to the chain by the sprocket, sprocket order and chain at the wrap angles described herein, with the maximum or minimum tensions imparted to the chain by sources external to the sprocket, the overall maximum tensions in the chain and sprocket system may be reduced in a beneficial way relative to where the sprocket is a straight sprocket of the same size operated with a chain, especially at resonance conditions. Moreover, in certain instances, where a sequence of pitch radii or root radii, or the repeating sequence or pattern has not been optimally selected to reduce chain tensions or does not uninterruptedly repeat because one or more teeth are missing from one or more pattern or sequence, coordinating the order with the selection of chain wrap angle is effective to reduce maximum chain tensions.

The order of the sprocket and the wrap angle of the chain are selected such that the resonance tension of the chain and sprocket assembly is minimized at resonance conditions. It also has been found that certain average chain wrap angles should not be used in a sprocket and chain system that is designed to provide at least one sequence of varying root or pitch radii which repeat at least twice. At the wrap angles described herein, the repeating sequences of root or pitch radii and timing of the tensions provided by the root or pitch radii are particularly effective to reduce maximum chain tensions during operation of the sprocket when operated with a chain at resonance conditions relative to where the sprocket is a straight sprocket operated with a chain at resonance conditions. Average wrap angles outside the average wrap angles defined by the equation set forth below should be avoided to best reduce maximum chain tensions:

average wrap angle=360N/Order±120/Order

where: N=1, 2, . . . , ORDER−1

and ORDER=sprocket order as a result of tensioning events which originate outside the chain and/or sprocket.

Average wrap angle is the average of angles about the sprocket center from where the chain first contacts the sprocket to where the chain last contacts the sprocket. It is the average difference of the angular distance between the chain engagement angle and disengagement angle. There may be some variation in wrap angles each time a sprocket is engaged or disengaged; hence, average angle is used herein.

In one aspect, the chain and sprocket using the wrap angles described herein includes a sprocket and chain wrapped around the sprocket where the sprocket has a central axis of rotation and a plurality of teeth including sprocket engagement surfaces. The sprocket teeth and the sprocket engagement surfaces are spaced about the periphery of the sprocket and the sprocket engagement surfaces are disposed to engage the chain with links interconnected at joints with pins with central axes. The sprocket engagement surfaces are spaced a distance from the sprocket central axis to dispose the chain at a pitch radius defined by the distance between the sprocket central axis and the pin axis of a chain link engaged by the sprocket engagement surfaces. In an important aspect, the sprocket engagement surfaces maintain constant distance between adjacent pin axes of links engaged with the sprocket engagement surfaces. This constant distance will be referred to herein as constant pitch. In another important aspect, the outer circumference of the sprocket, formed by its radially extending teeth, is generally circular or round.

In yet another aspect, the sprocket teeth and engagement surfaces are arranged to provide a sequence of a minimum root or pitch radius and a maximum root or pitch radius, an intermediate root pitch radii therebetween, and where the root or pitch radii sequence continually repeats themselves at least twice with each rotation of the sprocket. The root or pitch radii can be arranged in an ascending or descending order, e.g. where a sequence, for example, would be 1, 2, 3, 4, 4, 3, 2, 1, 1, 2, 3, 4, 4, 3, 2, 1. The chain wrap angle and order should be coordinated by wrapping the chain around the sprocket at a wrap angle defined by the equation, set forth above, which makes wrap angle a function of order. Angles outside this wrap angle should be avoided. Avoiding wrap angles outside the above-described equation and the sequence of root or pitch radii and timing of the tensions provided by the pitch radii are effective to reduce maximum chain tensions during operation of the sprocket when operated with a chain at resonance conditions relative to a straight sprocket and chain operated at resonance conditions.

In yet another aspect, the root or pitch radii do not precisely repeat in a pattern that would repeat at least twice as the sprocket turns over 360°, but rather have a sequence of root radii or pitch radii that emulates a repeating pattern of root or pitch radii. In this aspect the pitch radii or root radii sequence repeats with each 360° rotation of the sprocket in a way that the sequence is effective for imparting tensions to the chain timed with respect to tension loads imparted to the system from other sources. In this aspect, when there is a recurring tension event originating outside the sprocket, for example four such events over a 360° revolution of the sprocket, a given sprocket order is selected to emulate (such as four) where the sequence of pitch or root radii are selected to so emulate a fourth order sprocket which would have a pattern or sequence of root or pitch radii that would substantially repeat four times for tension reduction. This would be the case if the amplitude of the selected order (such as four) from the Fourier series of the sequence of the pitch or root radii or the sequence of the variation from mean pitch radii or mean root radii is consistent with a sprocket that has a repeating pattern or sequence of pitch or root radii for overall tension reduction in the chain. In this aspect, the sequence or pattern is particularly effective in reducing overall tensions at resonance. Further, in this aspect, the sprocket teeth and engagement surfaces may be arranged to provide a sequence which includes a minimum pitch radius and a maximum pitch radius, and an intermediate pitch radii therebetween.

Overall tension reduction can be achieved by coordinating the radii or pitch sequences, sprocket orders, and wrap angles as described herein without the need of positioning the sprocket on any particular side of the chain, such as a tight side of the chain. Further the coordination described herein permits the selection of wrap angles at selected orders to maximize tension reduction where the pitch or radii sequences alone do not result in the maximization of tension reduction. Further, the chain which engages the sprocket may be a roller chain or silent chain. Silent chains have teeth which drivingly engage the sprocket teeth and also generally have outer link plates which do not drivingly engage the sprocket, but may aid in alignment of the chains into the sprocket.

### BRIEF DESCRIPTION OF THE DRAWINGS

FIG. 1A shows a side elevation view illustrating a straight sprocket according to the prior art.

FIG. 1B is a side elevation view illustrating a random sprocket according to the prior art.

FIG. 1C illustrates a wrap angle where the chain first contacts and last contacts the sprocket.

FIG. 2 shows a sprocket substantially of the fourth order.

FIG. 3 is a side elevation view illustrating a random sprocket.

FIG. 4 is a graph comparing the maximum chain tensions of the sprockets of FIGS. 1-3 with the speed of an engine.

FIG. 5 is a detail view of a sprocket showing the teeth of a silent chain between adjacent sprocket teeth.

FIG. 6 illustrates wrap angle variation and how a wrap angle can vary as a result of the chain first engaging the sprocket differently from FIG. 1C when the chain leaves the sprocket.

FIG. 7 illustrates the wrap angles which are desired for a third order sprocket.

FIG. 8 illustrates wrap angles which should be avoided with repeating root or pitch radii sequences to achieve tension reduction in a third order sprocket.

FIG. 9 illustrates a layout for a three chain cam drive for a V8 engine with chain strand and shaft numbering, but having undesired chain wrap angles.

FIG. 10 illustrates a layout for a three chain cam drive for a V8 engine with strand and shaft numbering and having desired chain wrap angles.

FIG. 11 illustrates graphs which show maximum and minimum tensions for straight sprockets in the layout of FIG. 9 with the wrap angle of 175°.

FIG. 12 illustrates graphs which show maximum and minimum tensions for tension reducing sprockets in the layout of FIG. 9 with the wrap angles of 175°.

FIG. 13 illustrates graphs which show maximum and minimum tensions for tension reducing sprockets in the layout of FIG. 10 which has desired chain wrap angles.

### DETAILED DESCRIPTION

In the chain and sprocket system described herein, the effectiveness of chain and sprocket in reducing chain tensions is dependent on the combination of the number of radial variations or sprocket order, the amount and angle the chain wraps around the sprocket and the repeating sequence of pitch or root radii. The most effective amounts of wrap angle are defined by equation 1 set forth below:

$$WA = \frac{360 N}{ORDER} \pm \frac{120}{ORDER} \qquad ( 1 )$$

where: N=1, 2, . . . , ORDER−1
and ORDER=sprocket order as a result of tensioning events which originate outside the chain and/or sprocket.

In one important aspect using the wrap angle described above, a random sprocket may be used in an automotive chain and sprocket system, such as used in an engine timing system. The chain and random sprocket are coupled to an internal combustion engine which operates the chain and sprocket at variable speeds. The sprocket has a repeating sequence of root or pitch radii which are coupled to a chain at a wrap angle where the wrap angle of the chain with the sprocket and pattern are effective to reduce tensions imparted to the chain. The chain wrap angle, sprocket order and root or pitch radii sequence or pattern are selected to reduce tensions on the chain, especially at resonance, and to reduce noise generated as the chain contacts the sprocket.

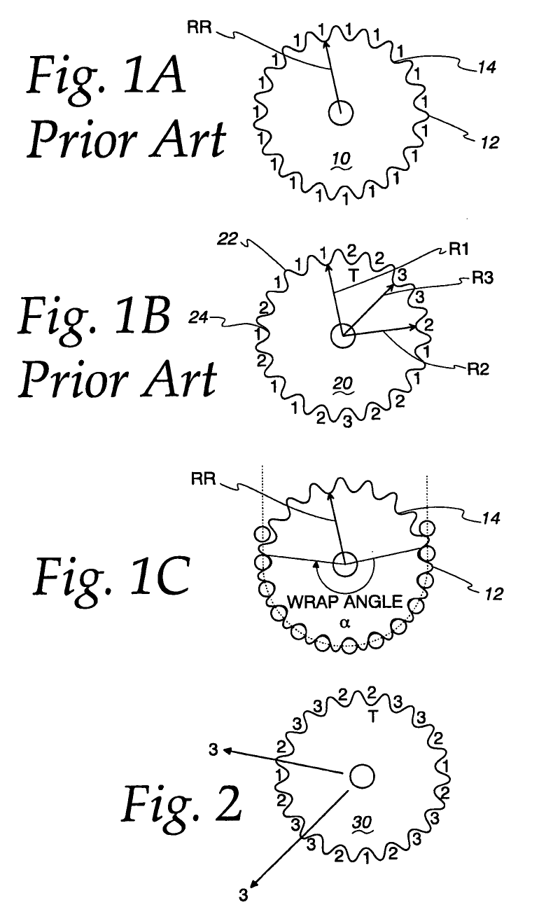

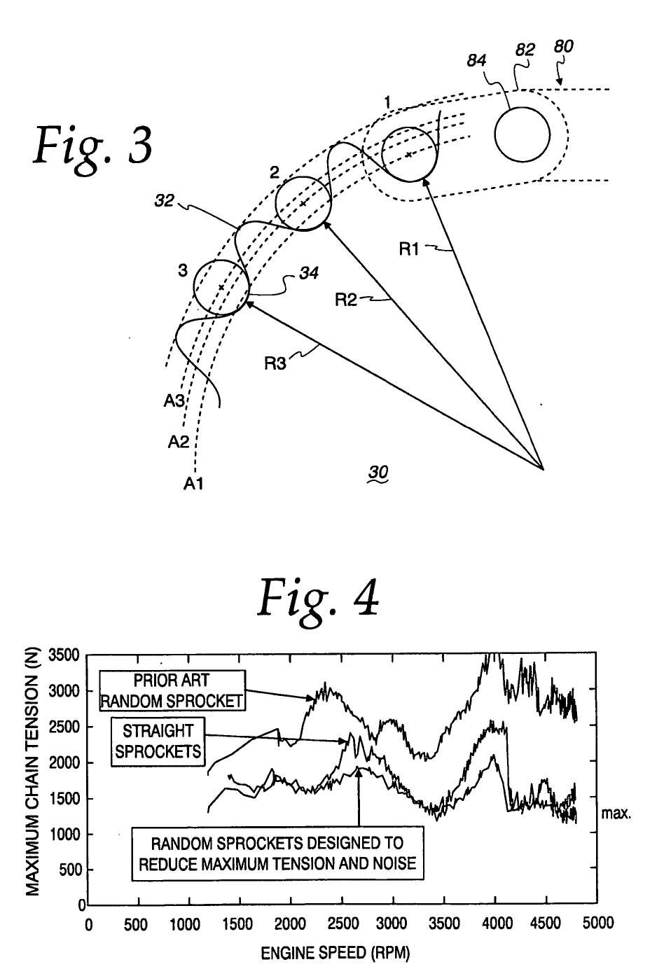

FIG. 1A illustrates a typical prior art sprocket 10. The sprocket 10 has nineteen radially extending teeth 12 disposed about its generally circular circumference for engaging links of a chain, such as the links 82 of chain 80 illustrated in FIG. 3. Straight sprockets, such sprocket 10, may have a variety of sizes, and, for example, may have an outer radius of approximately 3.0915 cm, as measured from the center of the sprocket 10 to tips of the teeth 12.

When reference herein is made to resonance and overall reduction of tension on a chain at resonance, torsional resonance is generally being referred to. In torsional resonance, the chain strands act as springs and the sprockets and shafts act as interias or masses. A simple chain drive with one driven sprocket and two chain strands has one torsional mode and acts like a rotational version of a simple spring mass system. It has a resonance frequency that amplifies the response (including shaft angular velocity and tension variation) to forces external to the sprocket. This torsional resonance can be excited by periodic torque fluctuations (such as cam torques) applied to the driven shaft at the same frequency as the resonance frequency. Resonance also can be excited by angular velocity variation at a driving (such as a crank) shaft or by internal tension fluctuations caused by engagement of the chain with the sprocket or variation in chain and sprocket shape.

In most chain drives this first torsional resonance occurs between 100 and 400 Hz. This is too low to be excited by engagement, but can easily be excited by the lower orders introduced by a random sprocket. Chain drives also can have transverse and longitudinal resonances. In a transverse resonance a chain strand vibrates like a guitar string. These can be excited by tension variations or movement at the end of the strands. While reducing chain tension variation can reduce transverse resonance activity, pitch radius variation can excite transverse resonance activity. In longitudinal resonance, the chain strands act as springs and the sprocket acts as a translating (as opposed to a rotating) mass. Typical chain drives do not have significant longitudinal resonance activity which will deleteriously affect the chain and sprocket. Most important in chain and sprocket drives is torsional resonance in the drive.

Sprocket root radii 14 are defined between adjacent teeth 12 for receiving pins or rollers 84 that connect the links 82 of the chain 80. The roots 14 have a generally arcuate profile to facilitate engagement with the pins 84 of the chain. Each root 14 has a root radius RR (see FIG. 3), defined as the distance from the center of the sprocket 10 to a point along the root 14 closest to the sprocket center. In the illustrated sprocket 10 of FIG. 1A, the root radius RR is approximately 2.57685 cm, as measured from the center of the sprocket 10 to the innermost point along the root 14. The sprocket 10 of FIG. 1A has all of its root radii RR equal to each other, and is generally known as a “straight” sprocket. Thus, the depths of each root 12 are the same, as indicated with reference numeral 1, corresponding to the first (and only) root radius RR for this type of sprocket 10.

Different tensioning events on a chain (not shown for sprocket 10) may be repeated on a periodic basis during each rotation of the sprocket. As mentioned above, the number of times a given tensioning event resulting from forces external to the sprocket is repeated in one rotation of the sprocket may be referred to as an “order” relative to the sprocket rotation. For example, a tensioning event of the chain that occurs once during each rotation of the sprocket may be termed a first order event, events occurring twice during one sprocket revolution may be termed second order events, etc.

When the tension in the chain 80 is observed during operation of the system, increases in the tension of the chain 80 may occur at certain orders of the sprocket 10 revolution. In a straight sprocket, such as the sprocket 10 of FIG. 1A, the only significant peak in the chain tension may occur at the order of the sprocket 10 corresponding to the number of teeth 12 on the sprocket 10, also known as the pitch order as mentioned above.

Thus, a chain rotating about the sprocket 10, having nineteen teeth 12, will have a peak in the tension imparted to the chain by the sprocket at the nineteenth order of the sprocket revolution, or nineteen times for every revolution of the sprocket 10. Peaks in the tension imparted to a chain by a sprocket 10 may also be due to other factors besides the number of sprocket teeth 12. For example, a sprocket 10 that is not rotating about its exact center may impart a tension to the chain at the first sprocket order, or once for every rotation of the sprocket, due to the eccentric rotation of the sprocket.

As mentioned above, in order to reduce noise generated by contact between the chain, and roots 14 and teeth 12 of a sprocket 10, “random” sprockets have been developed with plurality of different root radii. For example, a random sprocket may have two different root radii arranged in a predetermined pattern selected to decrease noise. A random sprocket may also be designed to incorporate three different root radii arranged in a predetermined pattern to further reduce noise generated by engagement of the chain 80 with the sprocket. The root radii may vary based on the particular system and sprocket design.

The random sprocket 20 illustrated in FIG. 1B is designed to reduce noise generated by engagement of a chain (not shown for sprocket 20) with the sprocket 20. The random sprocket 20 is similar to the straight sprocket 10 of FIG. 1A, but has three different root radii R1, R2, and R3 and thus three different root depths 1-3. In the sprocket 20 illustrated in FIG. 1B, the first root radii R1 is approximately 2.54685 cm, the second root radii R2 is approximately 2.57685 cm, and the third root radii R3 is approximately 2.60685 cm, as measured from the center of the sprocket 20 to the innermost points of the roots 24.

The root depths 1-3 are arranged in a pattern selected to modulate the engagement frequency between pins of a chain and roots 24 between adjacent teeth 22 of the sprocket 20 in order to reduce noise generation. As the pins of the chain move between adjacent roots 24 of the sprocket 22, the radial position at which the pins seat varies between a maximum radius, a nominal radius, and a minimum radius. In the noise reducing sprocket 20 of FIG. 1B, the pattern of root 24 depths, beginning at the timing mark T, is 2, 2, 3, 3, 2, 1, 1, 2, 2, 3, 2, 1, 1, 2, 1, 2, 1, 1, 1.

In the random sprocket 20 of FIG. 1B having three or more different root radii arranged in a pattern selected for noise reduction, the first, second, third, and fourth sprocket orders may impart relatively large tensions to the chain as compared to the remaining sprocket orders, especially when amplified by resonance. This increase in chain tensions corresponding to lower sprocket orders may have the undesirable effect of increasing the overall maximum chain tensions and reducing the overall life of the chain and/or sprockets.

Coordinating chain wrap angles, sprocket order and root radii or pitch radii sequences as described herein, provide reduced chain tensions with random sprockets. A plurality of different root or pitch radii are used with the wrap angles described herein. The radii are arranged in one or more patterns that are effective to permit reduction of chain tensions occurring at one or more selected sprocket orders by virtue of the external forces on the sprocket which are translated to the chain. The root or pitch radii patterns or sequences also may be selected to reduce chain noise or whine without the disadvantages of prior art random sprockets.

The sprocket pitch radii or root radii to be used with the wrap angles described herein are selected relative to a maximum radius and a minimum root radius as determined from the chain link size and configuration; the chain connecting pin size and spacing; and/or the number of sprocket teeth, tooth configuration and sprockets size. The root radii also may be selected relative to a nominal root or pitch radius which typically is the mid-point between the maximum and minimum radii.

The selection of varying root radii or varying pitch radii allows for the overall reduction of the pitch tensions generated by the chain to sprocket tooth/root contact. It is believed that this is due to the contact of the chain pins (or equivalent chain elements) with the sprocket teeth/roots at different times and at different tension levels as a result of the varying depths of the sprocket roots.

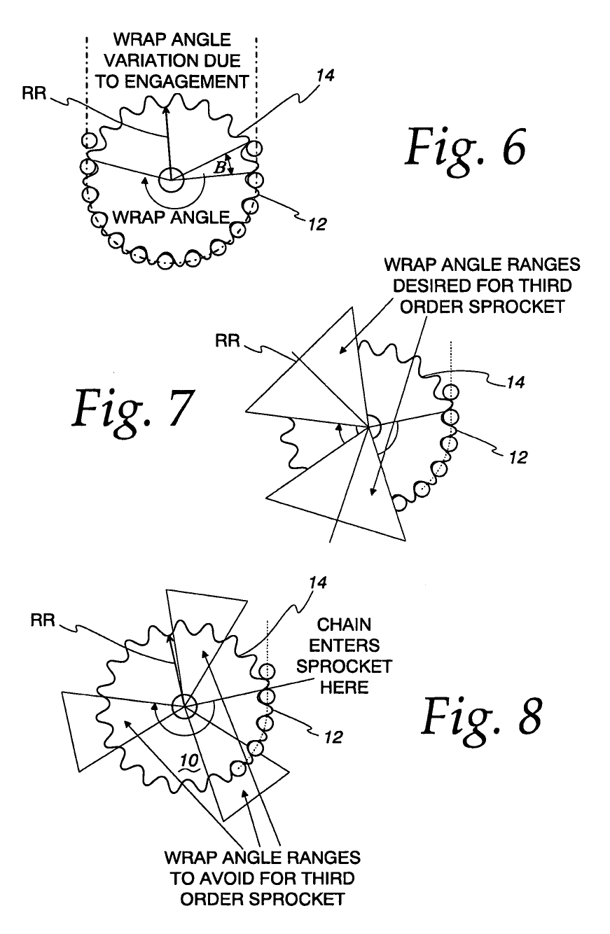

FIG. 1C illustrates a wrap angle around a sprocket and shows where the chain first contacts and last contacts the sprocket which contact points define the wrap angle α. Comparison of the wrap angles shown in FIG. 1C and FIG. 6 shows how chain wrap angles may vary, such as an angle generally shown as β in FIG. 6, due to how the chain engages the sprocket. As noted above, this is the reason why average wrap angle is used as described herein.

In one aspect, the root radii or pitch radii are arranged in a pattern that repeats at least twice, but the repetition may be multiple times around the outer sprocket circumference. This circumference has a generally round circumferential profile defined by the outer edges of the sprocket teeth. The pattern or sequence of root or pitch radii typically includes one or more sets or multiple, non-uniform or random root or pitch radii. Each set of radii typically includes the same number of root or pitch radii having the same length and arranged in the same order. However, beneficial results may be obtained where one pitch or root radius in one sequence is missing. When the phrase “substantially repeats” is used, this means one root or pitch radius may be missing from a repeating sequence of root or pitch radii. In other aspects, when there is a number of repeating sequences, and more than one sequence may be missing a radius coordinating the chain wrap angle, order and sequencing can provide chain tension reduction over a straight sprocket, especially at resonance. Further, different sets of root radii may have radii of different lengths, number and arrangement.

The use of such patterns of sequences or otherwise random root radii repeated along the circumference of the sprocket permits the cancellation or reduction of tensions to specific sprocket orders (or other orders based on the applicable reference). In doing so, the cumulative effect of canceling the tension forces permits the planned overall reduction of chain tension incorporated to the system by the sprocket at specific sprocket orders (or other reference orders).

The selection of the patterns of non-uniform or random root or pitch radii, and the lengths of the root radii further permit the use of major and minor patterns or sub-patterns of radii. Such major and minor patterns are effective to reduce the overall tensions imparted to the chain (and overall system) to multiple sprocket orders (or other applicable orders) and at different magnitudes. This along with the selection of chain wrap angles at given orders provides the additional flexibility in the selection of the sprocket root radii and patterns to offset multiple tension sources in the system and/or to balance the overall tensions on the chain and sprocket regardless of other sources of the tensional forces.

FIG. 2 illustrates a sprocket 30 according to an aspect of the invention wherein a random sprocket 30 is provided for both reducing chain tensions at a predetermined sprocket orders and reducing noise generated by engagement of the chain 80 with the sprocket 30. Similar to the straight sprocket 10 of FIG. 1A and the random sprocket 20 designed principally for noise reduction of FIG. 1B, the sprocket 30 has a plurality of radially extending teeth 32 disposed about its generally circular outer circumference for engaging the pins 84 of the chain 80. Roots 34 are defined between adjacent teeth 32 for receiving the pins 84 that connect the links 82 of the chain 80.

As seen in FIG. 3, the sprocket 2 of FIG. 3 has a maximum root radius R3, a nominal root radius R2, and a minimum root radius R1. As mentioned above, the maximum and minimum root radii are typically dependent on the link size and pin spacing, the shape of the sprocket teeth, etc. The root pattern of the sprocket 30 of FIGS. 2 and 3 is different from the root pattern of the sprocket 20 of FIG. 1B.

FIG. 2 illustrates a sprocket with root radii R1, R2, and R3 of approximately 2.54685 cm, 2.57685 cm, and approximately 2.60685 cm, respectively. The pattern of root depths, beginning at the timing mark T, is 2, 3, 3, 2, 1, 2, 3, 3, 2, 1, 2, 3, 3, 2, 1, 2, 3, 3, 2. The root radii pattern of the sprocket 30 contains a sequence, i.e., 2, 3, 3, 2, 1, that is substantially repeated (one root missing) four times around the circumference of the sprocket 30.

Thus, using the wrap angles at the orders as described herein and the use of a random pattern of root or pitch radii grouped in sets of sequences of root or pitch radii such as seen in this example (and others as discussed therein), provide a repeating pattern which may be used to effectively concentrate and cancel the lower order tensions of the chain 80 at the fourth order of the sprocket 30. This reduces the overall maximum tensions imparted to the chain 80 by the sprocket 30 and external forces imposed on the sprocket which create the chain tension. These chain tensions may be imparted to the chain 80 by various parts of the automotive engine system external to the sprockets, such as the shaft and/or the pistons.

These external sources may impart tension events to the chain 80 in addition to those imparted to the chain 80 by the sprockets 20 and 30 of the above examples. These external tensioning events may occur at intervals that correspond to orders of the sprocket revolution. The orders go from 2 to 12 and beyond, most commonly 2-4, 5, 6, and 8. Use of a combination of specific orders with chain wrap angles, random root radii and repeating root radii patterns all go to cancel tensions imparted to the chain 80 by the sprocket 30 and reduce the overall maximum chain tensions relative to a straight sprocket and also reduces chain noise or whine, especially at resonance conditions with engines (such as internal combustion engines) which operate at variable speeds.

The arrangement of the root radii or pitch radii may be selected by substantially repeating the radii pattern a number of times equal to the sprocket order at which it is desired to concentrate the chain tensions to reduce overall tension. To reduce maximum tensions due to a second order tensioning event, generally one would expect a pattern will be a second order pattern which will repeat twice to reduce overall tensions. In another example, to concentrate the tensions imparted to the chain 80 by the sprocket 30 of the invention at the fourth or more sprocket order, the arrangement of the root radii may comprise a pattern that substantially repeats four or more times around the sprocket 30.

As mentioned above, the repeating radii pattern and chain wrap angles can provide the benefit of reducing the overall maximum tensions imparted to the chain 80 by the sprocket 30, while also reducing noise generated by contact between the sprocket 30 and the chain 80. In connection with an internal combustion piston engine, the expected overall maximum tension reducing effects of the random sprocket 30 of the invention are illustrated in FIG. 4. The maximum tensions expected to be imparted to a chain by the sprockets 10, 20, and 30 of FIGS. 1-3 are compared with corresponding internal combustion piston engine speeds in FIG. 4, especially when speeds are at resonance condition such as at around 4000 rpm.

As illustrated in FIG. 4, the straight sprocket 10 of FIG. 1 imparts significantly lower maximum tensions to the chain 80 throughout the various engine speeds, but especially at resonance condition, relative to a random sprocket 20 designed only for noise reduction. In particular, it is expected that the maximum tensions imparted to the chain 80 by the random sprocket 20, designed principally for noise reduction, are higher near engine speeds of 4000 rpm, while the straight sprocket 10 would impart much lower maximum tensions to the chain for the same engine speed.

The maximum tensions imparted to the chain 80 by the random sprocket 30 designed for both noise reduction and reduced maximum chain tensions are expected to be significantly lower than for the random sprocket 20 designed principally to reduce noise. In fact, the tension reducing sprocket 30 may impart comparable, and in some instances, lower maximum tensions to the chain 80 than the straight sprocket 10 at engine speeds reflected in FIG. 4. Thus, FIG. 4 illustrates that the improved random sprocket design 30 of the invention is expected to provide for reduction of maximum overall chain tensions, an effect that is not available with prior random sprocket designs.

Although the fourth order was selected in the aspect of the invention illustrated in FIGS. 2 and 3, chain tensions may also be concentrated at other orders of the sprocket revolution as described in the table below. For example, a root or pitch radii pattern may be selected that is effective to concentrate chain tensions at the third order of the sprocket revolution. Such a pattern may include a root radii sequence that is substantially repeated three times around the circumference of the sprocket with a chain wrap angle as described above. For example, a root depth pattern for concentrating chain tensions at the third sprocket order may be 1, 2, 3, 3, 3, 2, 1, 2, 3, 3, 3, 2, 1, 2, 3, 3, 3, 2, 1, where a root depth pattern, i.e., 1, 2, 3, 3, 2, is substantially repeated three times for each revolution of the sprocket.

The tensions imparted to the chain 80 by the sprocket also may be concentrated at more than one sprocket order. For example, a root or pitch radii pattern may be selected that has a major root radii sequence repeating twice for each revolution of the sprocket and a minor sequence that repeats twice within each major sequence. Thus, in this aspect of the invention, the major and minor radii are provided by having the minor pattern repeating within the major repeating pattern. A benefit of having both major and minor repeating patterns at a selected order and with an appropriate chain wrap angle is the ability to further redistribute the sprocket orders and reduce tensions imparted to the chain 80 by the sprocket. Thus, for every revolution of a sprocket having such a pattern, the major radii sequence is effective to impart two tensioning events, while the minor radii sequence is effective to impart four tensioning events. The tensioning events imparted by the minor radii sequence may be of a lesser magnitude than the tensioning events imparted by the major radii sequence.

In order to reduce overall chain tensions in the chain and sprocket system, the tensions imparted to the chain 80 by the wrap angles and random and repeating root or pitch radii patterns, such as those of sprocket 30, are selected to at least partially offset tensions imposed on the chain 80 by such sources external to the sprocket 30 and chain 80. In one aspect, the orders of the sprocket revolution corresponding to peaks in the chain tension due to external sources, as well as those due to the sprocket 30, are determined. The sprocket 30 is then configured to cancel chain tensions at a sprocket order at which the chain tensions due to external sources are at a maximum. The chain wrap angle for such a sprocket order is determined by the relationships set forth in equation (1) above, or in one aspect, as set forth in the table below. This provides the potential to reduce the overall tensions in the chain 80, such as may occur if both the chain tension due to the sprocket 30 and the chain tension due to external sources are at their maximums due to resonance. For example, when the external tensions occur four times for every rotation of the sprocket 30, the root radii of the sprocket 30 may be arranged using the wrap angles described herein to concentrate the maximum tensions imparted to the chain 80 by the sprocket 30 at sprocket orders phased to at least partially cancel the external tensions imparted to the chain at resonance. In this manner, the external tensions in the chain 80 may be at least partially offset by the sprocket tensions in the chain 80 to reduce the overall tension in the chain 80 and increase the life cycle of both the chain 80 and the sprocket 30.

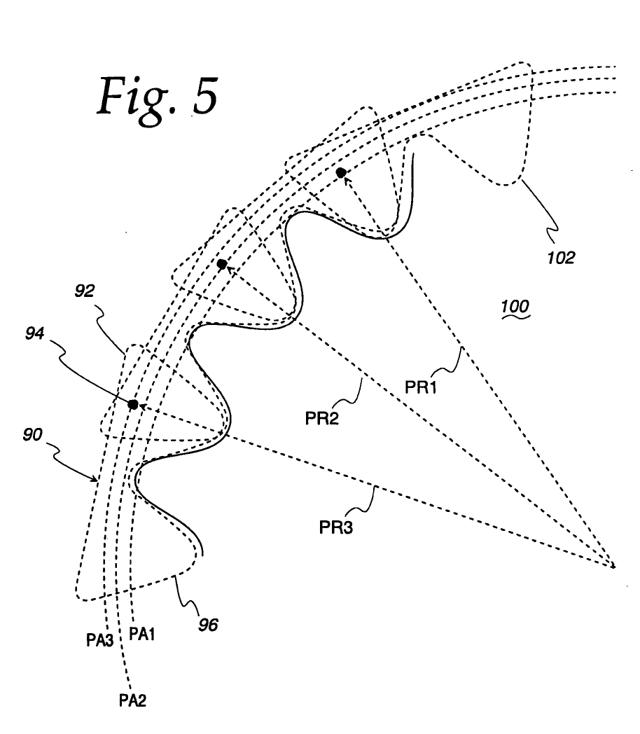

FIG. 5 illustrates a sprocket 100 according to an aspect of the invention for use with a silent chain 90 which has chain teeth which engage the sprocket. The silent chain 90 comprises a plurality of link plates 92, each having one or more teeth 96, pivotable relative to each other about joints 94. As the silent chain 90 rotates around the sprocket 100, the teeth 96 of the chain 90 engage teeth 102 of the sprocket 100. The sprocket 100 has three different pitch radii PR1, PR2, and PR3, as measured from the center of the sprocket 100 to joints 94 between link plates 92 having teeth 96 seated between teeth 102 of the sprocket 100. FIG. 5 illustrates arcs PA1, PA2, and PA3 through the centers of chain joints 94 that correspond to the pitch radii R1, R2 and R3. The pitch radii PR1, PR2, and PR3 are arranged in a pattern effective to distribute tensions imparted to the chain 90 by the sprocket 100 at one or more predetermined orders of the revolution of the sprocket 100.

A sprocket pattern order may be selected based on measured or predicted chain tensions. In one procedure, pin locations may be generated for a seated chain around the sprocket with the correct number of teeth, pitch length, and radial amplitude. The pin locations are positioned to achieve the correct pitch radius variation amplitude while maintaining a constant pitch length and a chain wrap angle as defined by equation (1) above. Then dynamic system simulations are run with the sprocket without external excitations. Strand tensions from the tension reducing sprocket are compared to strand tensions from a simulation of straight sprocket and external excitations. The tension reduction sprocket orientation is adjusted so that the sprocket's tensions will be out of phase with external tensions. A dynamic system simulation with the tension reduction sprocket and external excitations is run. Adjustments to the tension reduction sprocket orientation and amplitude are made if necessary. Simulations at a range of conditions are run to make sure the sprocket is always effective. A CAD based program, or similar software, is used to convert pin locations to the actual sprocket profile. Then prototype sprockets are made and tested on engines to confirm performance.

From the foregoing, it will be appreciated that the invention provides a method and apparatus for reducing maximum chain tensions in automotive systems, especially at resonance, and in one aspect, also reducing noise generated by the engagement between the chain and the sprocket. While the figures are illustrative of aspects of the invention, the invention is not limited to the aspects illustrated in the figures. By way of another example for sprockets which have 2, 3 or 8 orders, wrap angles are determined by applying equation (1) set forth above. In this illustration, Table I below sets forth wrap angles which should be used for each of 2 to 8 orders.

TABLE I
Wrap Angles Which Should Be Used

| | 2d Sprocket | 3rd Sprocket | 4th Sprocket | 5th Sprocket | 6th Sprocket | 7th Sprocket | 8th Sprocket |
|---|---|---|---|---|---|---|---|
| N | Order | Order | Order | Order | Order | Order | Order |
| 1 | 180° ± 60° | 120° ± 40° | 90° ± 30° | 72° ± 24° | 60° ± 20° | 51.4° ± 17.1° | 45° ± 15° |
| 2 | | 240° ± 40° | 180° ± 30° | 144° ± 24° | 120° ± 20° | 102.8° ± 17.1° | 90° ± 15° |
| 3 | | | 270° ± 30° | 216° ± 24° | 180° ± 20° | 154.3° ± 17.1° | 135° ± 15° |
| 4 | | | | 288° ± 24° | 240° ± 20° | 205.7° ± 17.1° | 180° ± 15° |
| 5 | | | | | 300° ± 20° | 257.1° ± 17.1° | 225° ± 15° |
| 6 | | | | | | 308.6° ± 17.1° | 270° ± 15° |
| 7 | | | | | | | 315° ± 15° |

These wrap angles set forth above in the table are used so that the sprocket or pulley radial variation generates sufficient tension variation at the drive resonance to cancel the tensions generated by external sources. Wrap angles outside these values result in insufficient tension generation due to radial variation. Set forth below in Table II are wrap angles which should be avoided where N and Order are set forth in the equation 1 above.

TABLE II
Wrap Angles to Avoid

| | 2d Sprocket | 3rd Sprocket | 4th Sprocket | 5th Sprocket | 6th Sprocket | 7th Sprocket | 8th Sprocket |
|---|---|---|---|---|---|---|---|
| N | Order | Order | Order | Order | Order | Order | Order |
| 0 | 90° ± 30° | 60° ± 20° | 45° ± 15° | 36° ± 12° | 30° ± 10° | 55.7° ± 8.6° | 22.5° ± 7.5° |
| 1 | 270° ± 30° | 180° ± 20° | 135° ± 15° | 100° ± 12° | 90° ± 10° | 77.1° ± 8.6° | 67.5° ± 7.5° |
| 2 | | 300° ± 20° | 225° ± 15° | 164° ± 12° | 150° ± 10° | 128.6° ± 8.6° | 112.5° ± 7.5° |
| 3 | | | 315° ± 15° | 228° ± 12° | 210° ± 10° | 180° ± 8.6° | 157.5° ± 7.5° |
| 4 | | | | 292° ± 12° | 270° ± 10° | 231.4° ± 8.6° | 202.5° ± 7.5° |
| 5 | | | | | 330° ± 10° | 282.9° ± 8.6° | 247.5° ± 7.5° |
| 6 | | | | | | 334.3° ± 8.6° | 292.5° ± 7.5° |
| 7 | | | | | | | 337.5° ± 7.5° |

FIG. 7 graphically illustrates the wrap angles which are desired for a third order sprocket.

FIG. 8 graphically illustrates wrap angles which should be avoided with repeating root or pitch radii sequences to achieve tension reduction in a third order sprocket. The wrap angles shown is FIG. 8 are illustrative of angles where overall tension reduction will not be fully enjoyed or even achieved at all. The triangles in FIG. 8 are the areas of wrap angles where the chain would disengage the sprocket and illustrate the wrap angle ranges to avoid for the third order sprocket.

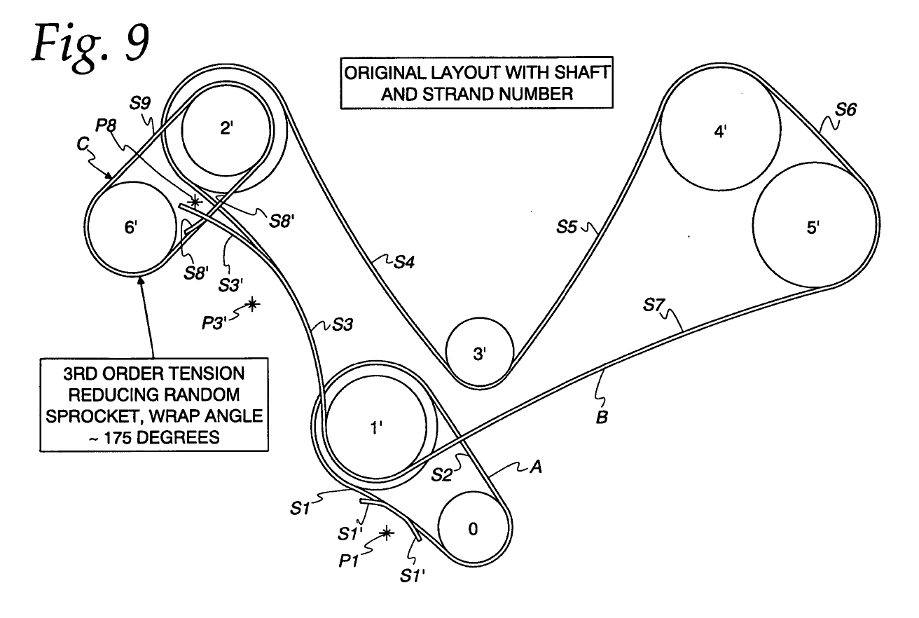

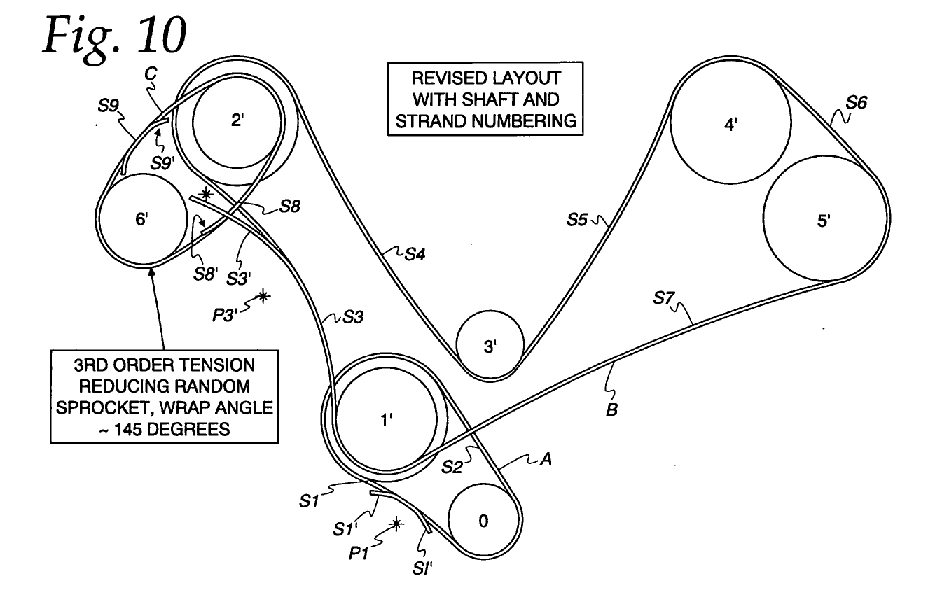

The invention was tested via computer simulation for a V 8 engine with a three chain cam drive having seven shafts, 0, 1′, 2′, 3′, 4′, 5′, and 6′. The drive has a tension reducing random sprocket on shaft 6′. The system has chains A, B and C, and as seen in FIG. 9, sprockets are on each side of the V. The tension reducing sprocket 6′ is on exhaust cam 6′ shown in FIG. 9. Strands S4, S5, S7 and S9 are guided with chain guides which are not shown. Strands S1, S3, and S8 have tension arms S1′, S3′, and S8′ urged into the strand at P1, P3 and P8. In FIG. 10 there is also a tension arm S9′ on strand 9.

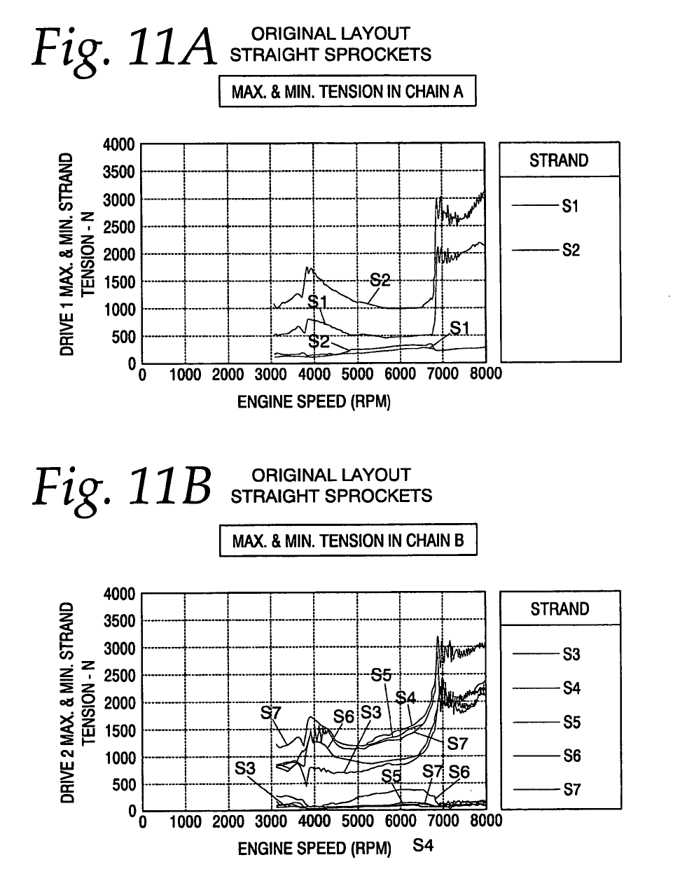

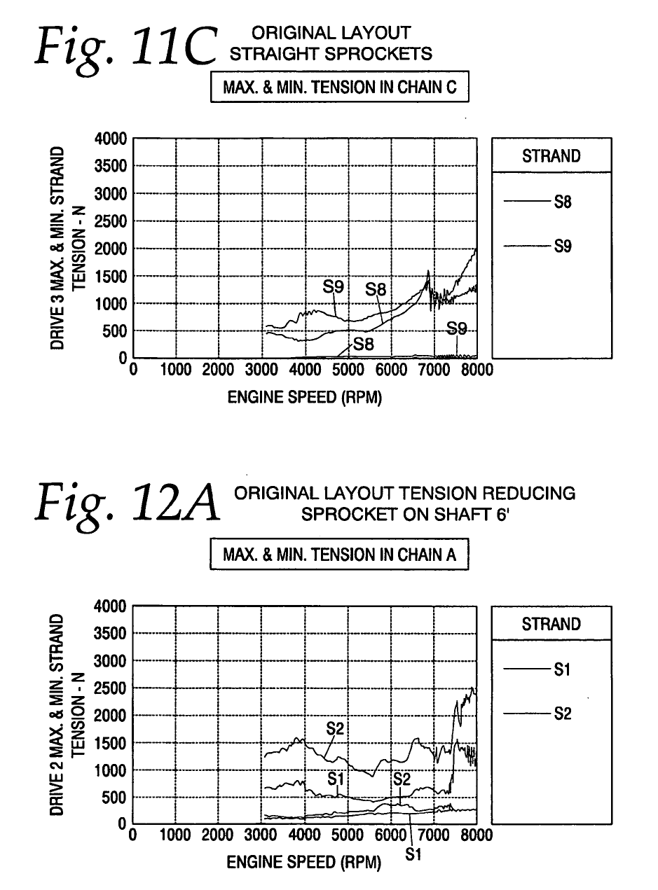

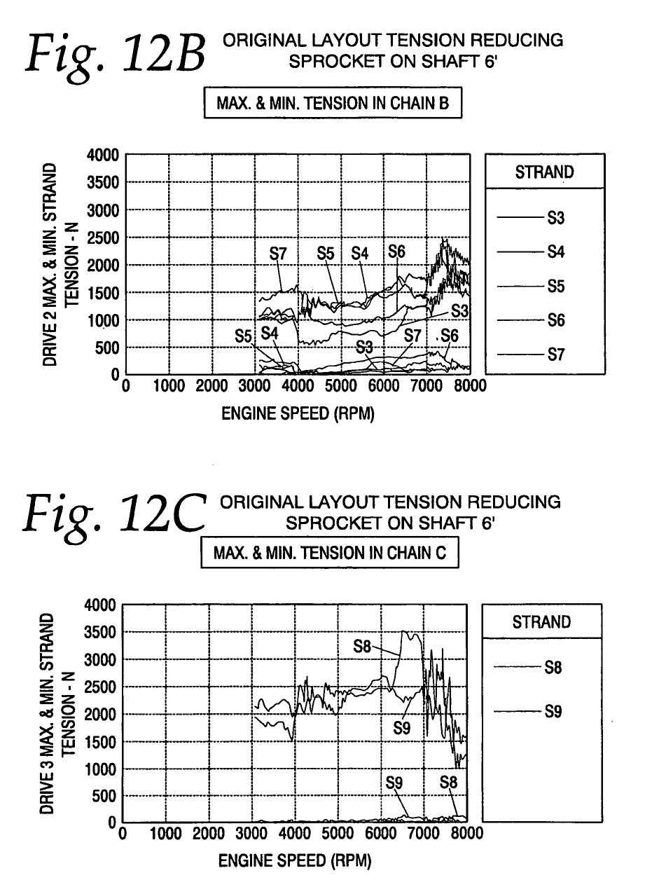

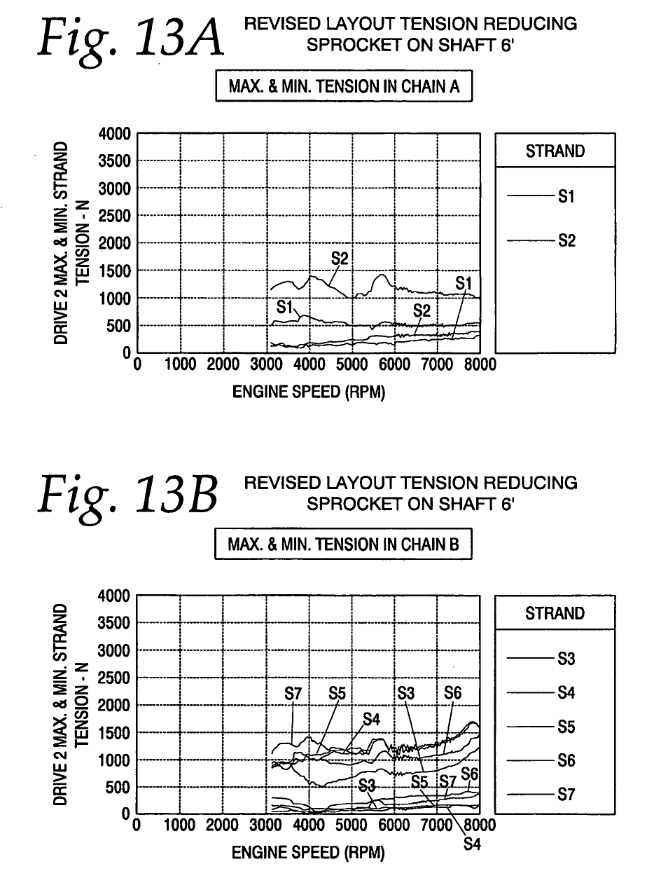

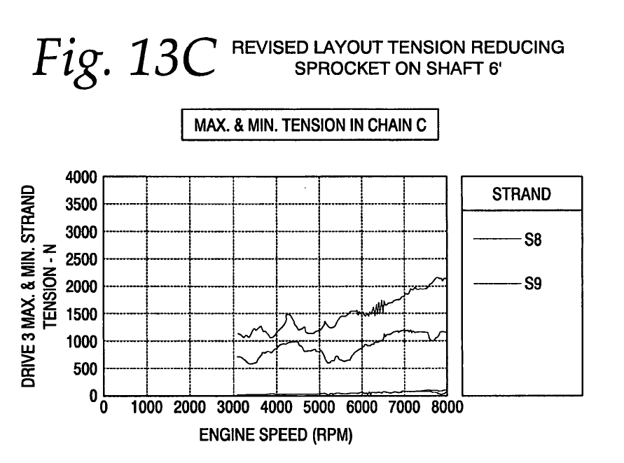

The sprocket on shaft 6′ is a third order sprocket, hence, the chain wrap angles which should be avoided are in the range of 120 to 200 degrees. The sprocket bank shown as 2′ and 6′ in FIG. 9 has a chain wrap angle of 175 degrees which is in the undesired range for an order sprocket. The effectiveness of these chain wrap angles was tested via simulation for a “straight sprocket” and tension reducing sprockets. To verify the improvement of the effectiveness of the tensions reducing sprocket on shaft 6′ by varying the chain wrap angle, two pitches to the length of the chain and a guide were added to make the chain path football shaped as seen if FIG. 10. This reduced the chain wrap angle to 145 degrees which is desired for a third order sprocket. As seen in FIGS. 11-13, the change in chain wrap angle, resulted in better tension reduction on chains A (strands S1 and S2), B (strands S3, S4, S5, S6 and S7) and C (strands S8 and S9).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A sprocket and chain system, the system comprising a sprocket and chain wrapped around the sprocket, the sprocket including a central axis of rotation and a plurality of teeth including sprocket engagement surfaces,
the teeth and the sprocket engagement surfaces spaced about the periphery of the sprocket, the sprocket engagement surfaces disposed to engage a chain with links interconnected at joints having a pin central axis,
the sprocket engagement surfaces spaced a distance from the sprocket central axis to dispose the chain at a pitch radius defined by the distance between the sprocket central axis and the pin axis of a chain link engaged by the sprocket engagement surfaces, and a sequence of root radii or pitch radii that emulates a repeating pattern or sequence of root or pitch radii which reduces overall tensions in the chain when there is at least one recurring tensioning event originating outside the sprocket over a 360° revolution of the sprocket,
the chain not wrapped around the sprocket at an average wrap angle outside the average wrap angle defined by the equation
average wrap angle=360N/Order±120/Order,
where N=1, 2, . . . , Order−1, and Order means sprocket order as a result of tensioning events which originate outside the chain and/or sprocket,
the sprocket order, the wrap angle, and the sequence of pitch radii or root radii being coordinated to be effective to reduce maximum chain tensions during operation of the sprocket when operated with a chain at resonance conditions relative to where the sprocket is a straight sprocket operated with a chain operating at resonance conditions, a Fourier series of the sequence of the pitch or root radii or the sequence of the variation from mean pitch radii or mean root radii providing an amplitude of the order which is consistent with a sprocket of the same order that has a repeating pattern or sequence of pitch or root radii which is effective for overall tension reduction in the chain at resonance conditions.

2. The sprocket and chain system according to claim 1, wherein the pitch radii sequence ascends from a minimum pitch radius to a maximum pitch radius and then descends from a maximum pitch radius to a minimum pitch radius.

3. The sprocket and chain system according to claim 1 where the chain and sprocket system has orders from 2 to 8.

4. The sprocket and chain system according to claim 1 wherein the chain and sprocket system has a sprocket with a second order pattern and the wrap angles selected from the group consisting of 90°±30° and 270°±30° are not used.

5. The sprocket and chain system according to claim 1 wherein the chain and sprocket system has a sprocket with a third order pattern and wrap angles selected from the group consisting of 60°±20°, 180°±20° and 30°±20° are not used.

6. The sprocket and chain system according to claim 1 wherein the chain and sprocket system has a sprocket with a fourth order pattern and wrap angles selected from the group consisting of 45°±15°, 135°±15°, 225°±15° and 315°±15° are not used.

7. The sprocket and chain system according to claim 1 wherein the chain and sprocket system has a sprocket with a fifth order pattern and wrap angles outside the wrap angles selected from the group consisting of 36°±12°, 100°±12°, 164°±12°, 228°±12° and 292°±12° are not used.

8. The sprocket and chain system according to claim 1 wherein the chain and sprocket system has a sprocket with a sixth order pattern and wrap angles selected from the group consisting of 30°±10°, 90°±10°, 150°±10°, 210°±10°, 270°±10° and 330°±10° are not used.

9. The sprocket and chain system according to claim 1 wherein the chain and sprocket system has a sprocket with a seventh order pattern and wrap angles selected from the group consisting of 55.7°±8.6°, 77.1°±8.6°, 128.6°±8.6°, 180°±8.6°, 231.4°±8.6° 282.9°±8.6° and 334.3°±8.6° are not used.

10. The sprocket and chain system according to claim 1 wherein the chain and sprocket has a sprocket with an eighth order pattern and wrap angles selected from the group consisting of 22.5°±7.5°, 67.5°±7.5°, 112.5°±7.5°, 157.5°±7.5°, 202.5°±7.5°, 247.5°±7.5°, 292.5°±7.5° and 337.5°±7.5° are not used.

11. A chain and sprocket drive system comprising:
a chain having a plurality of links interconnected by joints including a link pin so that the links are pivotable around a link pin axis relative to each other, the chain having teeth; and
at least one sprocket having a central axis of rotation and a plurality of sprocket teeth, the sprocket teeth having engagement surfaces disposed to engage the chain teeth, the sprocket teeth and sprocket engagement surfaces spaced about the periphery of the sprocket,
the sprocket engagement surfaces spaced a distance from the sprocket central axis effective to dispose the chain at a pitch radius defined by the distance between the sprocket central axis and the link pin axis of a chain link which has teeth engaged by the sprocket engagement surfaces,
the sprocket engagement surfaces of the at least one of the sprockets disposed to engage the chain teeth to provide a sequence of at least a minimum pitch radius, at least a maximum pitch radius, and at least one intermediate pitch radii therebetween, the distance between adjacent link pin axes of links having teeth engaged with the sprocket substantially constant, and
a pitch radii sequence including the minimum and the maximum pitch radii and an intermediate pitch radii continually repeating itself at least twice with each rotation of the sprocket,
the chain not wrapped around the sprocket at an average wrap angle outside the average wrap angle defined by the equation
average wrap angle=360N/Order±120/Order,
where N=1, 2, . . . Order −1, and Order means sprocket order as a result of tensioning events which originate outside the chain and/or sprocket,
the wrap angle, the sequence of pitch radii and order of the sprocket being coordinated to be effective to reduce maximum chain tensions during operation of the sprocket when operated with a chain at resonance conditions relative to where the sprocket is a straight sprocket operated with a chain operating at resonance conditions.

12. The chain and sprocket drive system according to claim 11, wherein the pitch radii sequence ascends from a minimum pitch radius to a maximum pitch radius and then descends from a maximum pitch radius to a minimum pitch radius.

13. The chain and sprocket drive system according to claim 11 where the chain and sprocket drive system has orders from 2 to 8.

14. The chain and sprocket drive system according to claim 11 wherein the chain and sprocket drive system has a sprocket with second order pattern and the wrap angles selected from the group consisting of 90°±30° and 270°±30° are not used.

15. The chain and sprocket drive system according to claim 11 wherein the chain and sprocket drive system has a sprocket with a third order pattern and wrap angles selected from the group consisting of 60°±20°, 180°±20° and 300°±20° are not used.

16. The chain and sprocket drive system according to claim 11 wherein the chain and sprocket drive system has a sprocket with a fourth order pattern and wrap angles selected from the group consisting of 45°±15°, 135°±15°, 225°±15° and 315°±15° are not used.

17. The chain and sprocket drive system according to claim 11 wherein the chain and sprocket drive system has a sprocket with a fifth order pattern and wrap angles outside the wrap angles selected from the group consisting of 36°±12°, 100°±12°, 164°±12°, 228°±12° and 292°±12° are not used.

18. The chain and sprocket drive system according to claim 11 wherein the chain and sprocket drive system has a sprocket with a sixth order pattern and wrap angles selected from the group consisting of 30°±10°, 90°±10°, 150°±10°, 210°±10°, 270°±10° and 330°±10° are not used.

19. The chain and sprocket drive system according to claim 11 wherein the chain and sprocket drive system has a sprocket with a seventh order pattern and wrap angles selected from the group consisting of 55.7°±8.6°, 77.1°±8.6°, 128.6°±8.6°, 180°±8.6°, 231.4°±8.6° 282.9°±8.6° and 334.3°±8.6° are not used.

20. The chain and sprocket drive system according to claim 11 wherein the chain and sprocket drive system has a sprocket with an eighth order pattern and wrap angles selected from the group consisting of 22.5°±7.5°, 67.5°±7.5°, 112.5°±7.5°, 157.5°±7.5°, 202.5°±7.5°, 247.5°±7.5°, 292.5°±7.5° and 337.5°±7.5° are not used.

21. A method of distributing tensions imparted to a chain having links looped around a sprocket, the chain and sprocket operating at variable speeds, the method comprising:
providing a sprocket having a central axis, a plurality of sprocket teeth and a plurality of sprocket engagement surfaces, the sprocket engagement surfaces spaced at a distance from the central axis to dispose the chain at a pitch radius defined by the distance between the sprocket central axis and a pin axis of a chain link engaged by the sprocket engagement surfaces;
providing the sprocket engagement surfaces so that they engage the chain to provide a sequence of at least a minimum pitch radius, at least a maximum pitch radius and at least an intermediate pitch radius therebetween, the sprocket engagement surfaces maintaining distances between adjacent pin axes of links engaged with the sprocket engagement surfaces constant;
arranging the sprocket engagement surfaces to provide a sequence in the different pitch radii so that the sequence continually repeats itself at least two times,
the wrap angle, the sequence of pitch radii and order of the sprocket being coordinated to be effective to reduce maximum chain tensions during operation of the sprocket when operated with a chain at resonance conditions relative to where the sprocket is a straight sprocket operated with a chain operating at resonance conditions.

22. The method of distributing tensions imparted to a chain according to claim 21 wherein the wrap angle and order have a relationship defined by the equation
average wrap angle=360N/Order±120/Order,
where N=1, 2, . . . Order−1, and Order means sprocket order as a result of tensioning events which originate outside the chain and/or sprocket,

23. The method of distributing tensions imparted to a chain according to claim 21, wherein the pitch radii sequence ascends from a minimum pitch radius to a maximum pitch radius and then descends from a maximum pitch radius to a minimum pitch radius.

24. The method of distributing tensions imparted to a chain according to claim 21 where the chain and sprocket has orders from 2 to 8.

25. The method of distributing tensions imparted to a chain according to claim 21 wherein the chain and sprocket has a sprocket with a second order pattern and the wrap angles selected from the group consisting of 90°±30° and 270°±30° are not used.

26. The method of distributing tensions imparted to a chain according to claim 21 wherein the chain and sprocket has a sprocket with a third order pattern and wrap angles selected from the group consisting of 60°±20°, 180°±20° and 300°±20° are not used.

27. The method of distributing tensions imparted to a chain according to claim 21 wherein the chain and sprocket has a sprocket with a fourth order pattern and wrap angles selected from the group consisting of 45°±15°, 135°±15°, 225°±15° and 315°±15° are not used.

28. The method of distributing tensions imparted to a chain according to claim 21 wherein the chain and sprocket has a sprocket with a fifth order pattern and wrap angles outside the wrap angles selected from the group consisting of 36°±12°, 100°±12°, 164°±12°, 228°±12° and 292°±12° are not used.

29. The method of distributing tensions imparted to a chain according to claim 21 wherein the chain and sprocket has a sprocket with a sixth order pattern and wrap angles selected from the group consisting of 30°±10°, 90°±10°, 150°±10°, 210°±10°, 270°±10° and 330°±10° are not used.

30. The method of distributing tensions imparted to a chain according to claim 21 wherein the chain and sprocket has a sprocket with a seventh order pattern and wrap angles selected from the group consisting of 55.7°±8.6°, 77.1°±8.6°, 128.6°±8.6°, 180°±8.6°, 231.4°±8.6° 282.9°±8.6° and 334.3°±8.6° are not used.

31. The method of distributing tensions imparted to a chain according to claim 21 wherein the chain and sprocket has a sprocket with an eighth order pattern and wrap angles selected from the group consisting of 22.5°±7.5°, 67.5°±7.5°, 112.5°±7.5°, 157.5°±7.5°, 202.5°±7.5°, 247.5°±7.5°, 292.5°±7.5° and 337.5°±7.5° are not used.

32. The method according to claim 22 wherein the chain and sprocket has a sprocket with a second order pattern and wrap angles outside the wrap angles of 180°±60° are used.

33. The method according to claim 22 wherein the chain and sprocket has a sprocket with a third order pattern and wrap angles selected from the group consisting of 120°±40° and 240°±40° are used.

34. The method according to claim 22 wherein the chain and sprocket has a sprocket with a fourth order pattern and wrap angles outside the wrap angles selected from the group consisting of 90°±30°, 180°±30° and 270°±30° are used.

35. The method according to claim 22 wherein the chain and sprocket has a sprocket with a fifth order pattern and wrap angles outside the wrap angles selected from the group consisting of 72°±24°, 144°±24°, 216°±24° and 288°±24° are used.

36. The method according to claim 22 wherein the chain and sprocket has a sprocket with a sixth order pattern and wrap angles outside the wrap angles selected from the group consisting of 60°±20°, 120°±20°, 180°±20°, 240°±20° and 300°±20° are used.

37. The method according to claim 22 wherein the chain and sprocket has a sprocket with a seventh order pattern and wrap angles outside the wrap angles selected from the group consisting of 51.4°±17.1°, 102.8°±17.1°, 154.3°±17.1°, 205.7°±17.1°, 257.1°±17.1° and 308.6°±17.1° are used.

38. The method according to claim 22 wherein the chain and sprocket has a sprocket with an eighth order pattern and wrap angles outside the wrap angles selected from the group consisting of 45°±15°, 90°±15°, 135°±15°, 180°±15°, 225°±15°, 270°±15° and 315°±15° are used.

39. A chain and sprocket drive system comprising:
a chain having a plurality of links interconnected by joints so that the links are pivotable around a link pin axis relative to each other; and
at least one sprocket having a central axis of rotation and a plurality of sprocket teeth and sprocket engagement surfaces between the teeth,
the sprocket teeth and the sprocket engagement surfaces spaced about the sprocket, the sprocket engagement surfaces disposed to engage the chain,
the sprocket engagement surfaces spaced a distance from the sprocket central axis and are effective to dispose the chain at a pitch radius defined by the distance between the sprocket central axis and the link pin axes of the chain links,
the sprocket engagement surfaces of the at least one of the sprockets disposed to engage the chain to provide a sequence of at least a minimum pitch radius, at least a maximum pitch radius, and at least a intermediate pitch radii therebetween,
the sprocket engagement surfaces maintaining constant the distance between adjacent link pin axes of links, and
the pitch radii sequence uninterruptedly and continually repeating itself at least twice with each rotation of the sprocket for imparting tensions to the chain timed with respect to tension loads imparted to the system from other sources,
the chain wrapped around the sprocket at an average wrap angle defined by the equation
wrap angle=360N/Order±120/Order,
where N=1, 2, . . . Order−1, and Order means sprocket order as a result of tensioning events which originate outside the chain and/or sprocket,
the wrap angle, the sequence of pitch radii and order of the sprocket being coordinated to be effective to reduce maximum chain tensions during operation of the sprocket when operated with a chain at resonance conditions relative to where the sprocket is a straight sprocket operated with a chain operating at resonance conditions.

40. The chain and sprocket drive system according to claim 39 wherein the chain and sprocket system has a sprocket with a second order pattern and the wrap angles selected from the group consisting of 90°±30° and 270°±30° are not used.

41. The chain and sprocket drive system according to claim 39 wherein the chain and sprocket system has a sprocket with a third order pattern and wrap angles selected from the group consisting of 60°±20°, 180°±20° and 300°±20° are not used.

42. The chain and sprocket drive system according to claim 39 wherein the chain and sprocket system has a sprocket with a fourth order pattern and wrap angles selected from the group consisting of 45°±15°, 135°±15°, 225°±15° and 315°±15° are not used.

43. The chain and sprocket drive system according to claim 39 wherein the chain and sprocket system has a sprocket with a fifth order pattern and wrap angles outside the wrap angles selected from the group consisting of 36°±12°, 100°±12°, 164°±12°, 228°±12° and 292°±12° are not used.

44. The chain and sprocket drive system according to claim 39 wherein the chain and sprocket system has a sprocket with a sixth order pattern and wrap angles selected from the group consisting of 30°±10°, 90°±10°, 150°±10°, 210°±10°, 270°±10° and 330°±10° are not used.

45. The chain and sprocket drive system according to claim 39 wherein the chain and sprocket system has a sprocket with a seventh order pattern and wrap angles selected from the group consisting of 55.7°±8.6°, 77.1°±8.6°, 128.6°±8.6°, 180°±8.6°, 231.4°±8.6° 282.9°±8.6° and 334.3°±8.6° are not used.

46. The chain and sprocket drive system according to claim 39 wherein the chain and sprocket system has a sprocket with a eighth order pattern and wrap angles selected from the group consisting of 22.5°±7.5°, 67.5°±7.5°, 112.5°±7.5°, 157.5°±7.5°, 202.5°±7.5°, 247.5°±7.5°, 292.5°±7.5° and 337.5°±7.5° are not used.

47. A chain and sprocket drive system comprising:
a chain having a plurality of links interconnected by joints so that the links are pivotable around a link pin axis relative to each other; and
at least one sprocket having a central axis of rotation and a plurality of sprocket teeth and sprocket engagement surfaces between the teeth, the sprocket teeth and the sprocket engagement surfaces spaced about the sprocket,
the sprocket engagement surfaces disposed to engage the chain at the link pin axes of the chain,
the sprocket engagement surfaces spaced a distance from the sprocket central axis and are effective to dispose the chain at a pitch radius defined by the distance between the sprocket central axis and the link pin axes of the chain links,
the sprocket engagement surfaces of the at least one of the sprockets disposed to engage the chain to provide a sequence of at least a minimum pitch radius, at least a maximum pitch radius, and at least a intermediate pitch radii therebetween,
the sprocket engagement surfaces maintaining constant the distance between adjacent link pin axes of links, and
the pitch radii sequence repeating with each rotation of the sprocket in a way that the sequence is effective for imparting tensions to the chain timed with respect to tension loads imparted to the system from other sources,
the chain not wrapped around the sprocket at an average wrap angle outside the average wrap angle defined by the equation
wrap angle=360N/Order±120/Order,
where N=1, 2, . . . Order−1, and Order means sprocket order as a result of tensioning events which originate outside the chain and/or sprocket,
the wrap angle, the sequence of pitch radii, sprocket order and timing of the tensions provided by the pitch radii effective to reduce maximum chain tensions during operation of the sprocket when operated with a chain at resonance conditions relative to where the sprocket is a straight sprocket operated with a chain operating at resonance conditions.

48. The chain and sprocket drive system according to claim 47 wherein the chain and sprocket drive system has a sprocket with a pattern that repeats at least twice and the wrap angles selected from the group consisting of 90°±30° and 270°±30° are not used.

49. The chain and sprocket drive system according to claim 47 wherein the chain and sprocket drive system has a sprocket with a pattern that repeats at least three times and wrap angles selected from the group consisting of 60°±20°, 180°±20° and 300°±20° are not used.

50. The chain and sprocket drive system according to claim 47 wherein the chain and sprocket drive system has a sprocket with a pattern that repeats at least four times and wrap angles selected from the group consisting of 45°±15°, 135°±15°, 225°±15° and 315°±15° are not used.

51. The chain and sprocket drive system according to claim 47 wherein the chain and sprocket drive system has a sprocket with a pattern that repeats at least five times and wrap angles outside the wrap angles selected from the group consisting of 36°±12°, 100°±12°, 164°±12°, 228°±12° and 292°±12° are not used.

52. The chain and sprocket drive system according to claim 47 wherein the chain and sprocket drive system has a sprocket with a pattern that repeats at least six times and wrap angles selected from the group consisting of 30°±10°, 90°±10°, 150°±10°, 210°±10°, 270° 10° and 330°±10° are not used.

53. The chain and sprocket drive system according to claim 47 wherein the chain and sprocket drive system has a sprocket with a pattern that repeats at least seven times and wrap angles selected from the group consisting of 55.7°±8.6°, 77.1°±8.6°, 128.6°±8.6°, 180°±8.6°, 231.4°±8.6° 282.9°8.6° and 334.3°8.6° are not used.

54. The chain and sprocket drive system according to claim 47 wherein the chain and sprocket system has a sprocket with a pattern that repeats at least eight times and wrap angles selected from the group consisting of 22.5°±7.5°, 67.5°±7.5°, 112.5°±7.5°, 157.5°±7.5°, 202.5°±7.5°, 247.5°±7.5°, 292.5°±7.5° and 337.5°±7.5° are not used.

55. The chain and sprocket drive system according to claim 47 wherein the sequence of pitch radii emulates a repeating sequence of pitch radii which reduces overall tensions in the chain when there is at least one recurring tensioning event originating outside the sprocket over a 360° revolution of the sprocket, and
a Fourier series of the sequence of the pitch radii or the sequence of a variation from mean pitch radii providing an amplitude of the sprocket order which is consistent with a sprocket of the same order that has a repeating sequence of pitch for overall tension reduction in the chain.
